(19) United States
(12) Patent Application Publication
(10) Pub. No.: US 2012/0070272 A1
(43) Pub. Date: Mar. 22, 2012

(54) METHOD FOR PRODUCING METAL ELEMENTS, IN PARTICULAR SEALING ELEMENTS

(75) Inventor: Rolf Prehn, Wipperfuerth (DE)

(73) Assignee: Federal-Mogul Sealing Systems GmbH, Herdorf (DE)

(21) Appl. No.: 13/322,062

(22) PCT Filed: May 20, 2010
(86) PCT No.: PCT/DE10/00564

§ 371 Date: Nov. 22, 2011

(30) Foreign Application Priority Data
May 22, 2009 (DE) 10 2009 022 393.2

(51) Int. Cl. F04D 29/08; B21D 43/28; B26D 1/00; B21B 23/00

(52) U.S. Cl. 415/173.1; 219/121.72; 72/365.2; 72/324; 83/13

(57) ABSTRACT

A method for producing metallic elements, and more particularly sealing elements, wherein a sheet metal strip or a foil strip having a predefinable length, width, and thickness is generated and the sheet metal strip or foil strip is formed to obtain a tube, the mutually opposing end regions or parts, or the entire contact surface of the sheet metal strip or foil strip, are connected to each other non-positively or positively or by bonding, or combinations thereof, and the entire length of the tube, or portions thereof, is subjected to a mechanical shape-forming process so that predefinable contours are introduced into the outer or inner circumferential surface of the tube in defined locations by a means, and the tube is divided into an appropriate number of individual elements, and in particular sealing elements, especially sealing rings for turbochargers.

### BACKGROUND OF THE INVENTION

The invention relates to a method for producing metallic elements, and more particularly sealing elements.

Such elements, notably sealing elements, are used quite frequently as sealing rings for turbochargers, stopper rings, borders, support disks or washers.

Such annular metallic elements have a broad range of applications. For example, metallic annular sealing rings, which typically have either a C-shaped or a V-shaped cross-section, are used for turbochargers. Until now, such sealing elements have been used only rarely as exhaust system flange gaskets. Stopper rings are used in production cylinder head gaskets. However, to date, they have been die-cut from sheet metals, resulting in high material expenditure and high costs.

Given the fact that modern power units or internal combustion engines place ever greater demands on the sealing technology, because both combustion pressures and combustion temperatures are steadily rising, increasingly better solutions must be found and, to some extent, materials in ever higher quality must also be employed. The costs for such materials, which have a wide variety of sealing properties, are at times significant, especially when large, narrow rings must be die-cut from sheet metal.

DE 197 55 391 A1 relates to a method for producing a sealing ring, in which first a hollow cylinder is formed from sheet metal, wherein the cylinder is transformed into the shape of a reinforcement ring by a post-shaping operation and subsequently joined to a sealing lip made of polymeric material. The sheet metal is transformed into the shape of the hollow cylinder by roll-forming, incurring no waste.

U.S. Pat. No. 4,162,569 discloses a method for producing a metallic flat gasket. Disks are cut from a tube having varying wall thicknesses, or a flange is integrally molded to a face of the tube. By conducting various finishing operations, annular elements are obtained, which can be used as combustion chamber borders of a cylinder-head gasket.

### SUMMARY OF THE INVENTION

It is the object of the invention to provide an alternative method for producing metallic elements, and more particularly sealing elements, which is associated with the least possible material use.

The sealing elements thus produced should be suitable for specific applications, notably in the area of vehicle drive systems.

This object is achieved by a method for producing metallic elements, and more particularly sealing elements, by generating a sheet metal strip or a foil strip having a predefinable length, width, and thickness and forming the sheet metal strip or foil strip so as to obtain a tube, by connecting the mutually opposing end regions or parts, or the entire contact surface of the sheet metal strip or foil strip to each other non-positively or positively or by bonding, or combinations thereof, and subjecting the entire length of the tube, or portions thereof, to a mechanical shape-forming process so that predefinable contours are introduced into the outer or inner circumferential surface of the tube in defined locations by a means, and by dividing the tube into an appropriate number of individual elements, and more particularly sealing elements.

The object is thus obtained, in general, by first producing an intermediate product, this being a tube, similar to the prior art according to DE 197 55 391 A1, and subsequently at least partially forming it or contouring it on the wall side and then cutting off or cutting out, or die-cutting, individual ring elements from the tube.

It is likewise conceivable to divide the profiled tube into sections having predefinable lengths and then to cut open/form these sections to obtain individual ring elements or sealing elements.

Suitable shape-forming processes both for individual sealing elements and the entire tube include hydroforming, rubber pad forming, or the use of upsetting presses.

The separation process to obtain ring elements or sealing elements can be effected, for example, by roller cutting, laser cutting, or water jet cutting.

To begin with, sheet metal strips or foil strips having defined lengths and widths are generated from a base body in the form of a foil, or sheet metal having a predefinable thickness, for example by laser cutting, fine blanking or similar methods. The essential aspect here is that the mutually opposing edges, which are subsequently welded to each other, are free of burrs. It may be helpful in some instances not to weld straight ends to each other, but rather to employ a zigzag or wave contour so as to achieve better joining of the edge regions and additionally provide the weld seam with further advantageous properties (for example, a certain rigidity or the like).

Different manners of creating annular or disk-shaped metallic elements, and more particularly sealing elements, having various designs will be described hereafter.

A tube that is produced as described above from wound or rolled sheet metal strips or foil strips is relatively easy to handle and can be provided to a mechanical contouring or shape-forming process. To this end, it is conceivable to introduce any arbitrary profile (for example a C, V, or W shape) into the outer/inner circumferential surface of the tube, for example by means of a multi-roller system (double-roller system). This can be done either at one tube end alone, so as to then cut off individual rings from the tube end, or over a certain length of the tube or the entire length of the tube, so as to then generate individual or multiple rings simultaneously. For this purpose, the profiling process can be carried out in one step or in several steps.

Segments or rings are cut off the contoured tube (end). Suitable methods for this purpose include roller cutting, laser cutting, water jet cutting or the like. Preferably, roller cutting is employed because in this way either no loss of material is incurred at all, or the loss of material is minimized, and additionally the resulting edges of the ring element can still be provided with a special edge contour.

It is likewise possible to cut a contoured tube so as to obtain individual rings and to subsequently form these tube sections in a press so as to obtain disks. To this end, a wide variety of profiles (flat, inclined and the like) can be generated.

A wide variety of materials can be employed to generate metallic elements, and more particularly sealing elements. Depending on the required temperatures, cold rolled strips are suitable, in addition to alloys for high-temperature applications. A person skilled in the art will again select an appropriate material, depending on the forming requirements.

The sealing elements thus produced can be employed in the area of vehicle drive mechanisms; for example they can serve as sealing rings in a turbocharger, as stopper rings in the area of a flat gasket, and notably a cylinder head gasket, as borders, or as support disks or washers.

The invention is shown in the drawings based on an exemplary embodiment, and is described as follows. In the drawings:

### BRIEF DESCRIPTION OF THE DRAWINGS

FIGS. 1 to 3 show different modes for generating tubes from a sheet metal strip or foil strip;

FIG. 4 is a schematic diagram of an option for contouring the outer circumferential surface of the tube according to FIGS. 1 to 3;

FIG. 5 shows cross-sections of annular metallic elements;

FIG. 6 is a schematic diagram of a cylinder-head gasket, containing a sealing element produced by the method according to the invention.

### DETAILED DESCRIPTION OF THE INVENTION

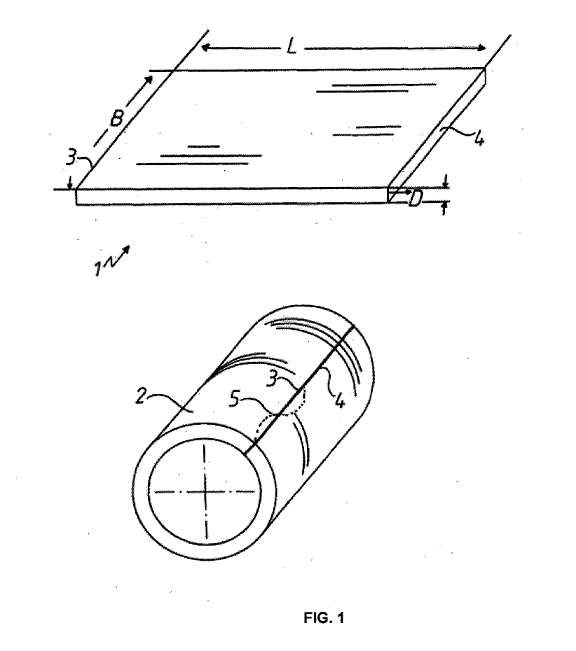

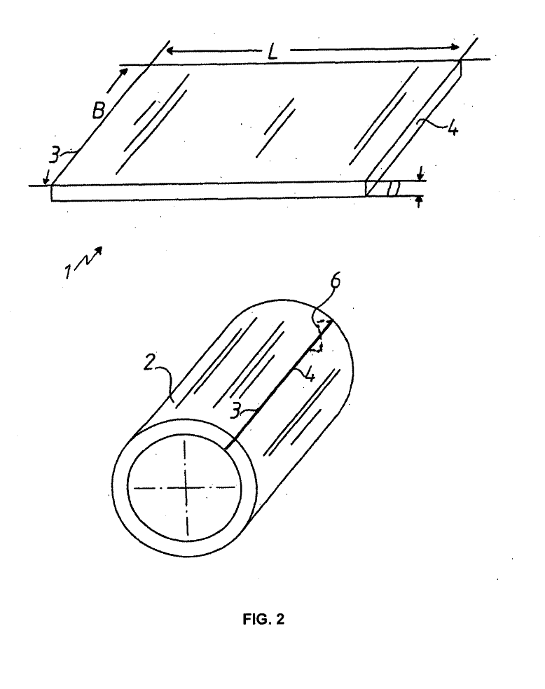

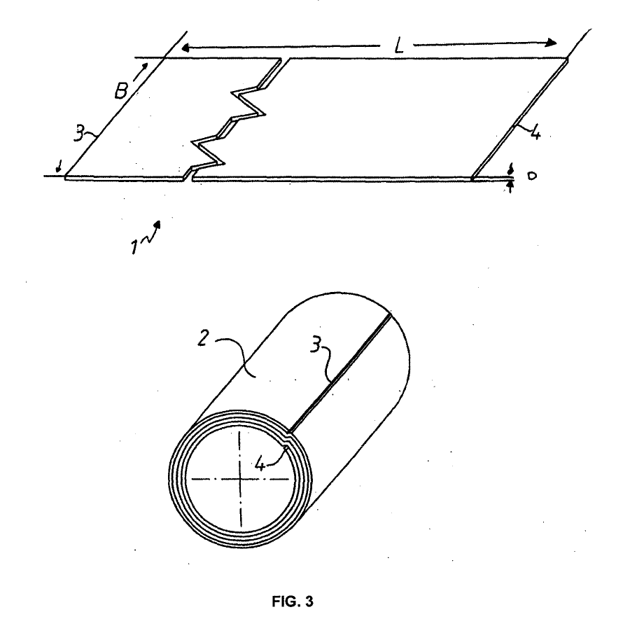

FIGS. 1 to 3 show sheet metal strips or foil strips 1, which have predefined lengths L, widths B, and thicknesses D, and which have already been cut out from a base body (not shown). So as to generate various properties in the end product, sheet metal strips or foil strips 1 having different rolling directions can be employed. The respective sheet metal strip or foil strip 1 is formed so as to obtain the respective tube 2 shown in FIGS. 1 to 3. The end regions 3, 4 of the tubes 2 shown in FIGS. 1 and 2 are connected to each other over the entire length by bonding, or by non-positive or positive joining techniques, and in this example, they are connected to each other by welding. Profiles of the end regions 3, 4, which serve to produce defined properties in the end product are indicated only by dotted lines.

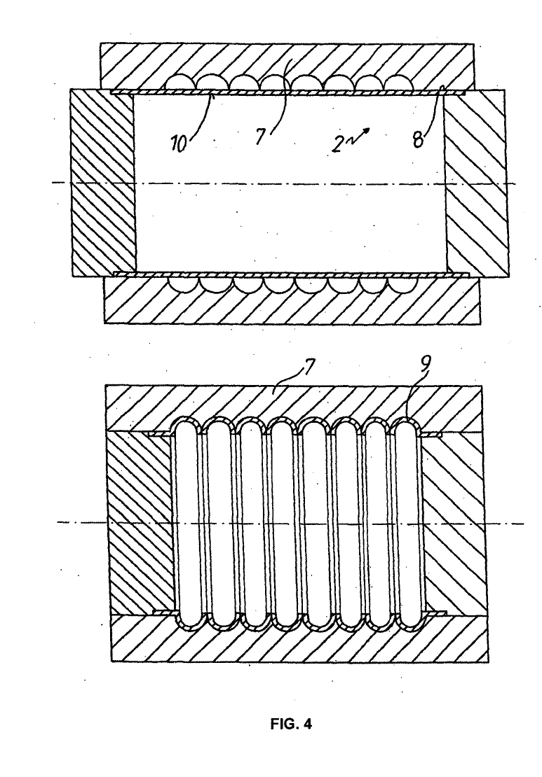

FIG. 4 is a schematic diagram of the tube 2 shown in FIG. 1 or 2. Defined contours 9 are impressed in the outer circumferential surface 8 of the tube 2 using hydroforming (tool 7), for example. Rubber pad forming or the use of upsetting presses is also a suitable alternative. Separation so as to obtain annular elements is carried out in a downstream production step. As an alternative, a multi-roller system can be applied to the inner circumferential surface 10 of the tube 2, as needed, so as to obtain different cross-sectional shapes in the finished end product.

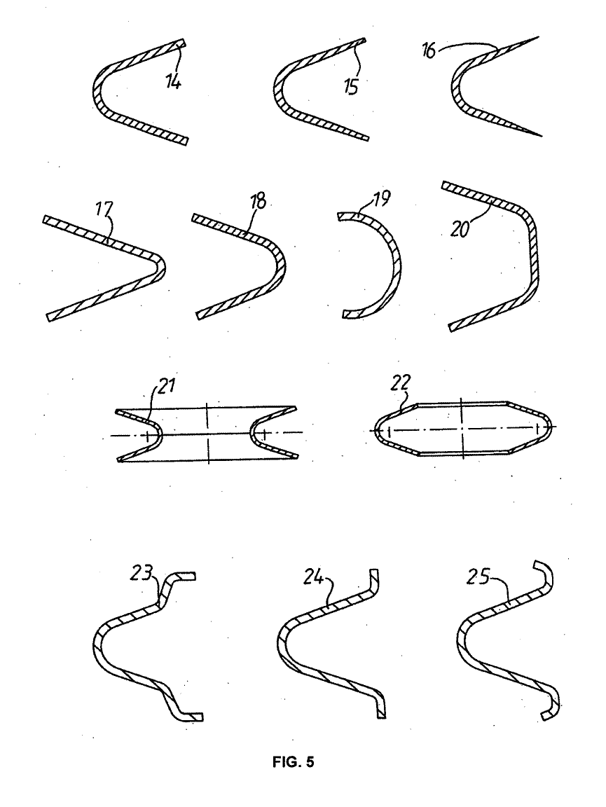

FIG. 5 shows cross-sections of annular end products 14 to 25, which can be employed, for example, as sealing elements for the aforementioned applications.

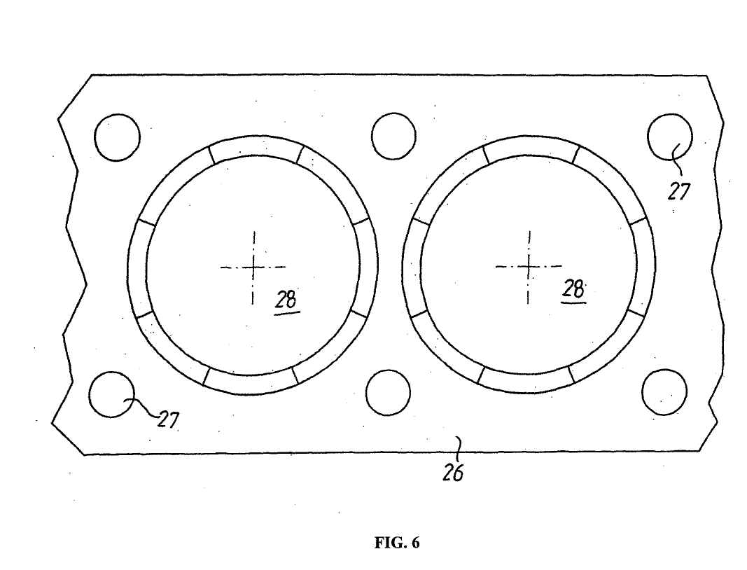

FIG. 6 is a schematic diagram of a cylinder head gasket 26, which can be used, for example, in the area of an internal combustion engine. Screw through-holes 27, combustion chamber through-passages 28, and, for example, a sealing element 17 to 21 according to FIG. 5 are apparent.

1. (canceled)

2. The turbocharger having a sealing ring according to claim 9, wherein in the method of producing the sealing ring the mechanical shaping process comprises forming grooves of predetermined contour by means of a multi-roller shaping apparatus.

3. The turbocharger having a sealing ring according to claim 9, wherein in the method of producing the sealing ring the dividing of the tube is by roller-cutting.

4. The turbocharger having a sealing ring according to claim 9, wherein in the method of producing the sealing ring the dividing of the tube is by laser cutting.

5. The turbocharger having a sealing ring according to claim 9, wherein in the method of producing the sealing ring the dividing of the tube is by water jet cutting.

6.-8. (canceled)

9. A turbocharger having a sealing ring produced by a method comprising forming a sheet metal strip or foil strip into a tube as an intermediate product, operatively connecting mutually opposed or overlapping ends or end regions of the tube, by a mechanical shaping process contouring at least a portion of an outer or an inner circumferential surface of the tube along at least a portion of the length of the tube, and dividing the tube into a plurality of elements comprising respective turbocharger sealing rings.
